(19) United States
(12) Patent Application Publication
(10) Pub. No.: US 2016/0034706 A1
(43) Pub. Date: Feb. 4, 2016

(54) DEVICE AND METHOD OF ANALYZING MASKED TASK LOG

(71) Applicant: FUJITSU LIMITED, Kawasaki-shi (JP)

(72) Inventors: Satoshi Munakata, Kawasaki (JP); yuji mizobuchi, kawasaki (JP); Kuniharu Takayama, Tama (JP)

(21) Appl. No.: 14/740,671

(22) Filed: Jun. 16, 2015

(30) Foreign Application Priority Data
Jul. 30, 2014 (JP) 2014-155160

(51) Int. Cl. G06F 21/62; G06F 17/30

(52) U.S. Cl. CPC G06F 21/6245; G06F 17/30321; G06F 17/30371

(57) ABSTRACT

A method of analyzing a masked task log obtained by masking part of a task log, which is a record of a task performed in a workflow system, the method includes: acquiring a plurality of pieces of disclosed information that are viewable to a plurality of users based on unmasked information in the masked task log; specifying relevance between the plurality of pieces of disclosed information and a plurality of tasks performed in the workflow system, the plurality of tasks including the task; and calculating an index based on the relevance by a processor, the index indicating a possibility that content of the masked task log is determined from the plurality of pieces of disclosed information.

### CROSS-REFERENCE TO RELATED APPLICATIONS

This application is based upon and claims the benefit of priority of the prior Japanese Patent Application No. 2014-155160, filed on Jul. 30, 2014, the entire content of which are incorporated herein by reference.

### FIELD

The embodiment discussed herein is related to an analyzing technique for a masked task log.

### BACKGROUND

Conventionally, job efficiency improvement is achieved through performing tasks in accordance with a workflow system. In particular, a user can reduce the time taken for a trial and error process when performing a task and more carry out efficiently a job by retrieving and referring to a task log, which is a record of tasks previously performed by other users.

Since a task log sometimes includes confidential information that is prohibited from being disclosed to the outside or to other departments, an administrator of a workflow system sets whether to disclose the task log or not. It is desirable for a user of the workflow system that more task logs be disclosed in order to find a task log that is useful for a job which the user is about to perform.

From the viewpoint of protection of personal information and preservation of business confidentiality, a masking technique for replacing proper nouns such as personal names, place names, and organization names included in text data with symbols or common nouns is proposed. Applying such a masking technique to a task log to be disclosed makes it possible to disclose a task log that includes confidential information by masking the confidential parts. In this case, a trade-off between usefulness of the task log and risk of exposing confidential information after the masking process has to be devised. That is, a task log is more useful but the risk of confidential information being determined is greater as more information remains disclosed in the task log after a masking process.

According to a conventional masking technique, named entities that can be disclosed are defined in advance in a white list, and named entities that are not included in the white list among named entities included in a masking target document are masked. Then, the white list is redefined based on a readability index represented by a ratio of the number of unmasked named entities to the total number of named entities included in the document. In this way, a trade-off between usefulness and risk is adjusted.

As a representative safety index that indicates the difficulty of identification of a person from anonymized data, there is known an index called k-anonymity, which indicates that at least k combinations that have the same values in a plurality of fields exist. One option is to use this index for indicating the risk of a masked document.

The above technique is disclosed, for example, in Takanori UGAI et al. “Case based evolutional workflow system”, Information Processing Society of Japan Technical Report, October 2002, pp. 77-81 and Yohei IKAWA et al. “A Masking System for Confidential Documents by Unmasking Safe Words” Information Processing Society of Japan Technical Report, July 2006, pp. 421-428.

### SUMMARY

According to an aspect of the invention, a method of analyzing a masked task log obtained by masking part of a task log, which is a record of a task performed in a workflow system, the method includes: acquiring a plurality of pieces of disclosed information that are viewable to a plurality of users based on unmasked information in the masked task log; specifying relevance between the plurality of pieces of disclosed information and a plurality of tasks performed in the workflow system, the plurality of tasks including the task; and calculating an index based on the relevance by a processor, the index indicating a possibility that content of the masked task log is determined from the plurality of pieces of disclosed information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an organization structure and an example of a job structure;

FIG. 2 is a schematic view illustrating the flow of a task performed in the workflow system;

FIG. 3 is a schematic view illustrating an example of a task log;

FIG. 4 is a functional block diagram of a determining ease calculating device according to the present embodiment;

FIG. 5 is a diagram illustrating an example of a task log table;

FIG. 6 is a diagram illustrating an example of an operation judgment table;

FIG. 7 is a diagram illustrating an example of a disclosed range table;

FIG. 8 is a diagram illustrating an example of a job structure DB;

FIG. 9 is a diagram illustrating an example of a document table;

FIG. 10 is a diagram illustrating a relationship among the tables;

FIG. 11 is a diagram illustrating an example of a white list;

FIG. 12 is a diagram illustrating an example of a task log before masking and an example of a task log after masking;

FIG. 13 is a diagram illustrating an example of a task log table to which the task log after masking has been added;

FIG. 14 is a diagram illustrating an example of an operation judgment table to which an operation judgment after masking has been added;

FIG. 15 is a diagram for explaining relevance between documents and between task logs;

FIG. 16 is a diagram for explaining how to calculate a transition possibility;

FIG. 17 is a diagram for explaining how to calculate an identification possibility;

FIG. 18 is a diagram for explaining how to calculate relevance;

FIG. 19 is a diagram for explaining relevance between task logs in the job structure;

FIG. 20 is a diagram illustrating an example of a display screen;

FIG. 21 is a diagram illustrating an example of a disclosed range table;

FIG. 22 is a block diagram illustrating an outline configuration of a computer that functions as the determining ease calculating device according to the present embodiment;

FIG. 23 is a flow chart illustrating an example of a determining ease calculating process according to the present embodiment; and

FIG. 24 is a diagram for explaining relevance between documents and between task logs.

### DESCRIPTION OF EMBODIMENT

The conventional technique for redefining the contents of a white list by using readability as an index has a problem in that the risk of masked confidential information being determined from disclosed information that is retrieved based on disclosed named entities is not taken into consideration.

Furthermore, k-anonymity has a problem in that the risk of confidential information being determined from combinations of disclosed information items retrieved based on disclosed named entities is not able to be expressed as an index. In particular, in a workflow system, a task log that can be referred to depends on a job structure or the like. Therefore, k-anonymity is insufficient as an index for indicating the risk of determining masked confidential information in the task log.

An object of one aspect of the technique disclosed in the present embodiment is to calculate the ease of which a masked part in a task log in a workflow system can be determined in consideration of combinations of disclosed information items.

An exemplary embodiment of the disclosed technique is described below in detail with reference to the drawings. In the present embodiment, an example in which an administrator of a workflow system calculates the ease of determining a target task log when determining whether or not to disclose a non-disclosed task log and the degree of masking in the case of disclosing the non-disclosed task log is described.

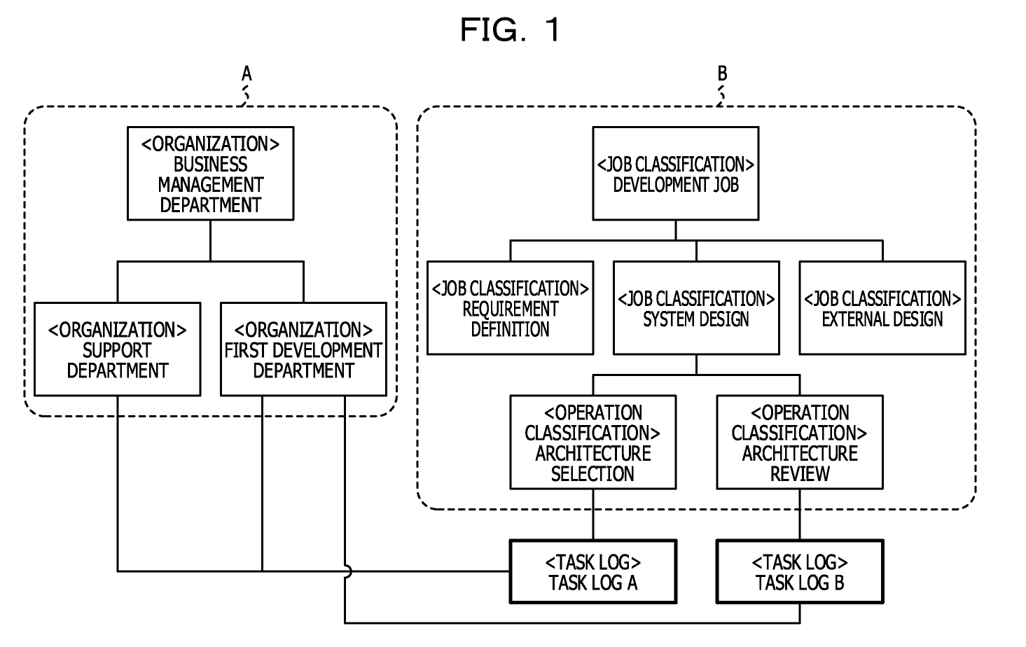

A workflow system which is a premise of the present embodiment is constructed, for example, in accordance with an organization structure illustrated in A of FIG. 1 and a job structure illustrated in B of FIG. 1. The job structure in the present embodiment is expressed by a tree structure in which nodes indicative of types of jobs (<JOB CLASSIFICATION> in FIG. 1) and nodes indicative of tasks (<OPERATION CLASSIFICATION> in FIG. 1) are linked based on the type of jobs and a relationship between the tasks. In the workflow system which is a premise of the present embodiment, a task log, which is a record of tasks performed by a user of the workflow system in accordance with a workflow, is stored for each task.

Each task log thus stored may be arranged so that the task log is disclosed to an organization to which a user who performed a task indicated by the task log belongs or may be arranged so that the task log is disclosed to all organizations. In the present embodiment, the case where a task log is disclosed only to an organization to which a user who performed a task belongs is referred to as “non-disclosure”, whereas the case where a task log is disclosed to all organizations is referred to as “disclosed (full disclosure)”. For example, in the example of FIG. 1, a task log A is disclosed to the Support Department and the First Development Department, whereas a task log B is disclosed only to the First Development Department to which a user performed a task belongs (i.e., non-disclosure). In this way, each task log is associated with the organization structure and the job structure.

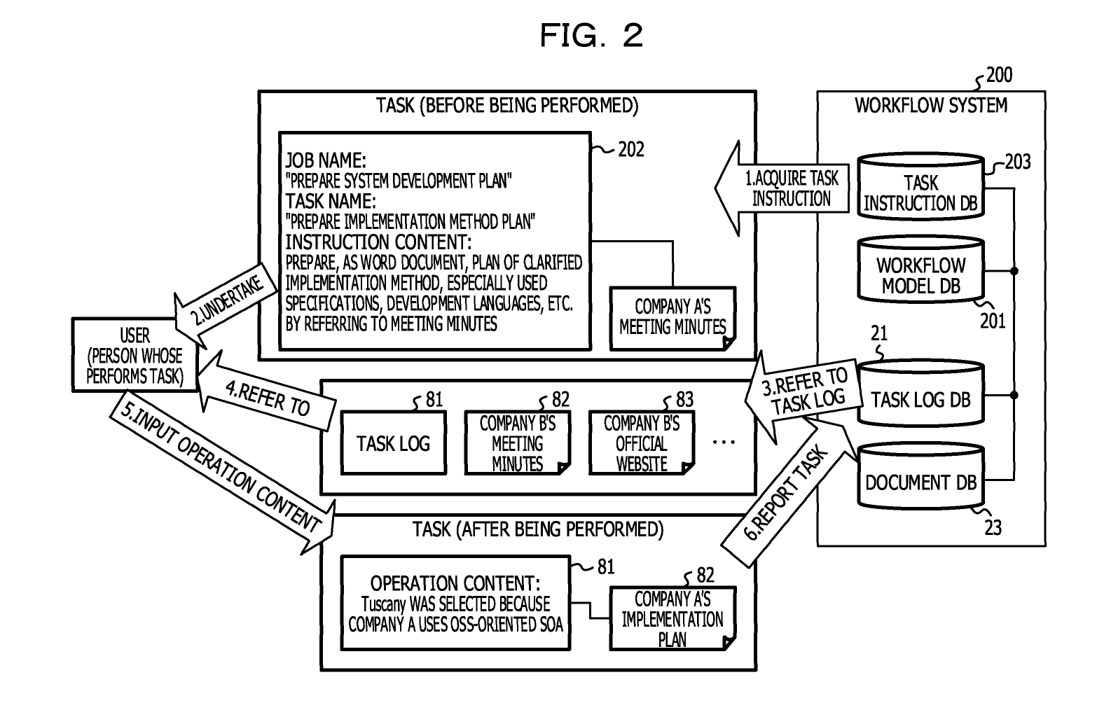

FIG. 2 schematically illustrates the flow of a task performed in a workflow system 200 that is a premise of the present embodiment. In the workflow system 200, a plurality of workflow models, which are models of jobs performed in accordance with the workflow system 200, are stored in a workflow model database (DB) 201. A task instruction 202 containing a job name, a task name, instruction content, and the like of a task performed in accordance with this workflow model is stored in a task instruction DB 203.

A user who performs a task acquires the task instruction 202 from the task instruction DB 203 and performs the task. In performing the task, the user retrieves a task log 81 used as a reference for performing the task from among task logs 81 which are records of tasks previously performed and stored in a task log DB 21 of the workflow system 200. The user makes a judgment concerning the task about to be performed by referring to the retrieved task log 81 and a document 82 that is referenced in the task log 81. The document 82 is an example of “disclosed information” of the disclosed technique. Examples of the document 82 include a document that is created through performing a task and is disclosed and a Web site that is retrieved based on information described in the task log 81. The document 82 is stored in a document DB 23.

The user records, in a task log 81, operation content concerning performing a task including the judgment concerning the task made by referring to the other task log 81 and the document 82, reports the task to a person who requested the task, and stores the task log 81 in a non-disclosed state in the task log DB 21.

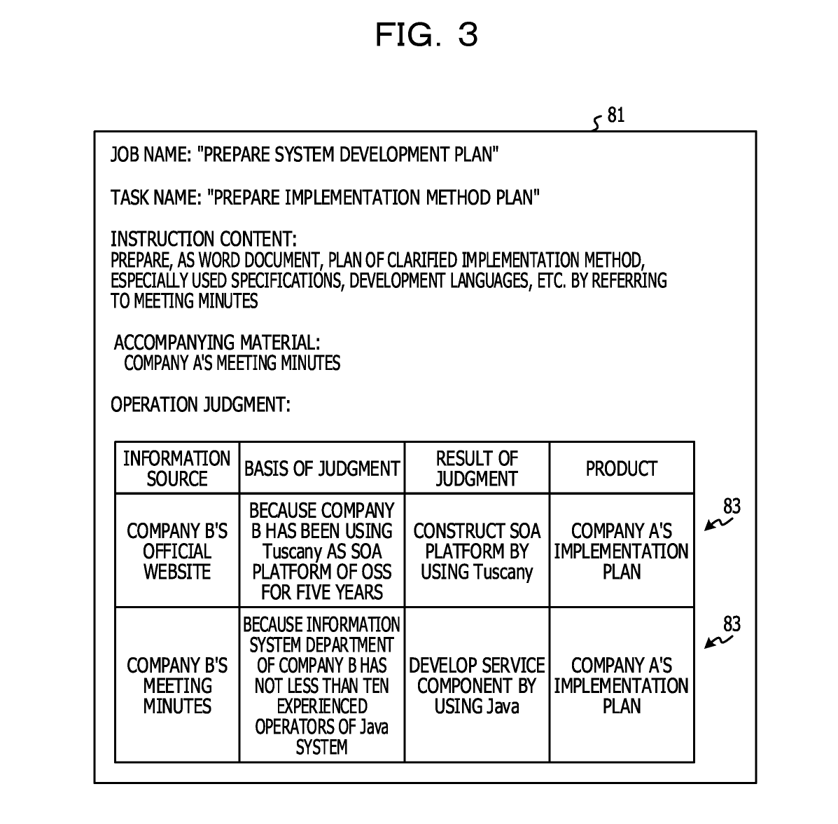

FIG. 3 schematically illustrates an example of the task log 81 in the present embodiment. As illustrated in FIG. 3, the task log 81 in the present embodiment includes an operation judgment 83, which is information indicative of a judgment made with reference to the other task log 81 and the document 82 referenced in the task log 81. With regard to the operation judgment 83, a single judgment that is semantically separable from other judgments is handled as a single piece of information. Accordingly, there are cases where a single task log 81 includes a plurality of operation judgments 83. In the example of FIG. 3, each row of the table labeled with “OPERATION JUDGMENT” represents a single operation judgment 83. This means that the single task log 81 includes two operation judgments 83. Note that the operation judgment 83 is an example of “reference information” of the disclosed technique. A determining ease calculating device 10 according to the present embodiment uses, as a task log 81 for which determining ease is to be calculated, a task log 81 that has been recorded and stored as described above.

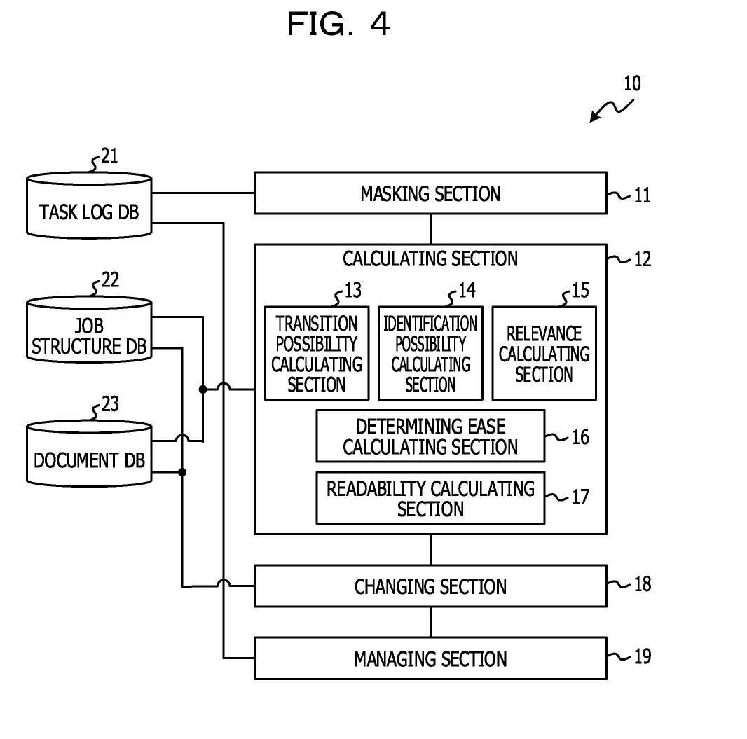

As illustrated in FIG. 4, the determining ease calculating device 10 according to the present embodiment includes a masking section 11, a calculating section 12, a changing section 18, a managing section 19, the task log DB 21, a job structure DB 22, and the document DB 23.

The task log DB 21 includes a task log table 21A, an operation judgment table 21B, and a disclosed range table 21C.

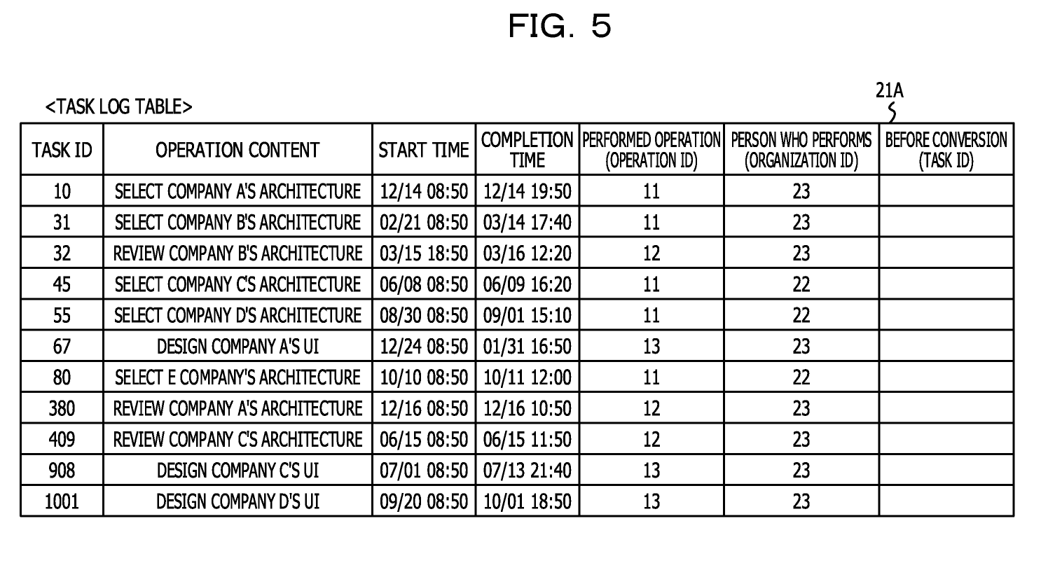

FIG. 5 illustrates an example of the task log table 21A. In the task log table 21A, a task log 81, which is a record of performed tasks, is stored for each task as described above. The task log table 21A of FIG. 5 includes task IDs, which are identification information of tasks, the content of performed operations, start times, completion times, operation IDs indicative of the performed operations, organization IDs of organizations to which persons who performed the tasks belong, and task IDs before conversion. The operation IDs are data defined in an operation classification table that will be described later, and the organization IDs are data defined in an organization table that will be described later. The task IDs before conversion are task IDs indicative of original task logs 81 that have not been subjected to a masking process that will be described later.

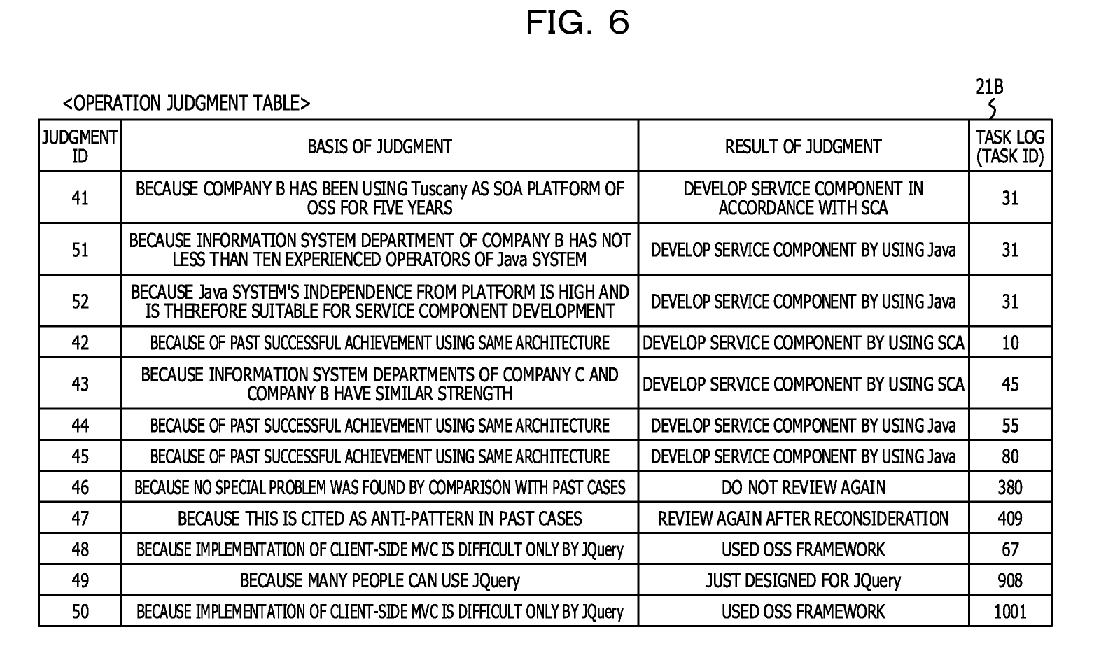

FIG. 6 illustrates an example of the operation judgment table 21B. In the operation judgment table 21B, for example, the content of the operation judgment 83 of the task log 81 schematically illustrated in FIG. 3 is stored. The operation judgment table 21B of FIG. 6 includes judgment IDs, which serve as identifiers of the operation judgments 83, bases of judgments, results of judgments, and task IDs of corresponding task logs 81.

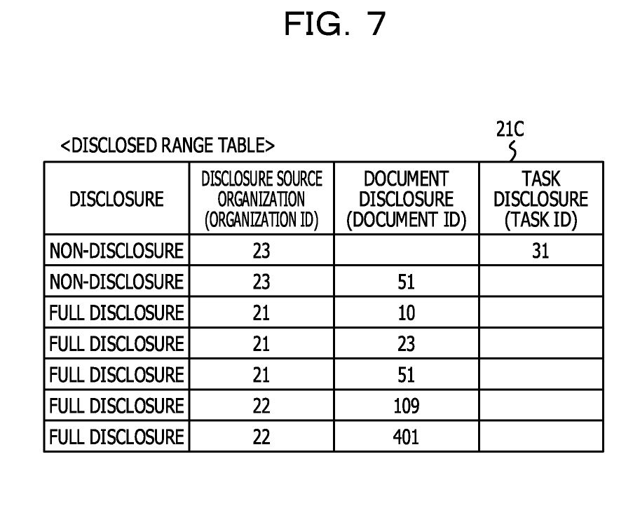

FIG. 7 illustrates an example of the disclosed range table 21C. Setting information indicative of disclosure or non-disclosure of each of the task logs 81 stored in the task log table 21A and the documents 82 in the document DB 23 is stored in the disclosed range table 21C. The disclosed range table 21C in FIG. 7 includes organization IDs indicative of disclosure source organizations which created the document 82 or the task log 81, document IDs, which are identification information of the documents 82, and task IDs. In the example of FIG. 7, whether the document 82 or the task log 81 is disclosed only to the disclosure source organization (non-disclosure) or disclosed to all organizations is determined for each document 82 and for each task log 81. For example, a task log 81 whose task ID is 31 is set so as to be disclosed only to an organization whose organization ID is 23, and a document whose document ID is 10 is set so as to be disclosed to all organizations.

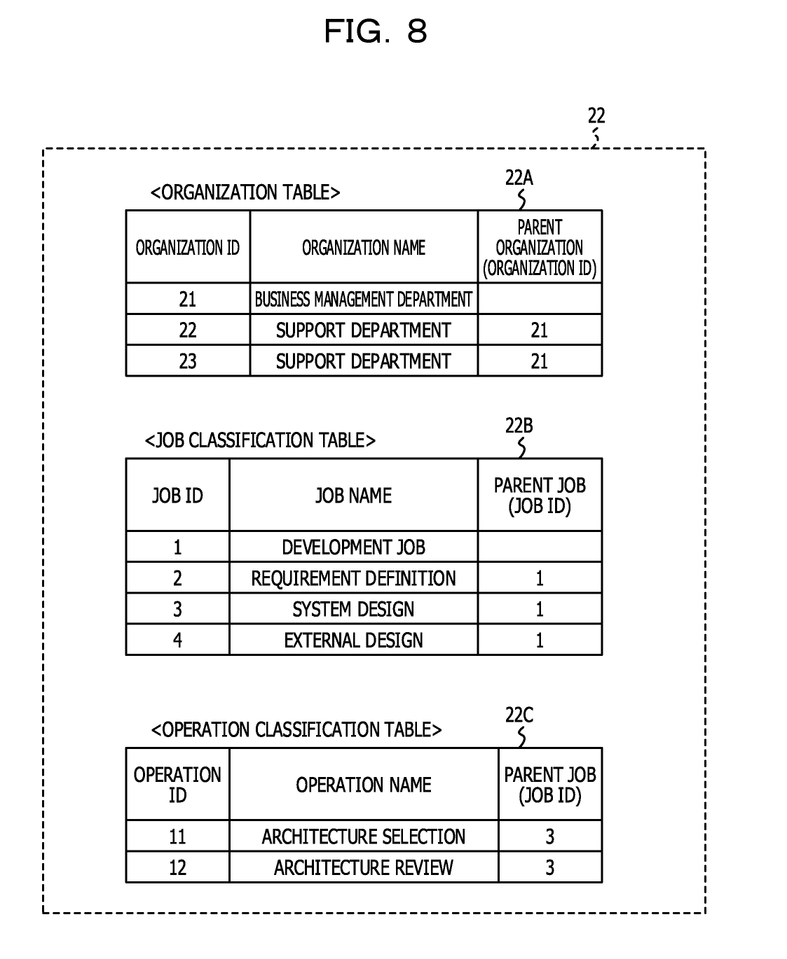

As illustrated in FIG. 8, the job structure DB 22 includes, for example, an organization table 22A, a job classification table 22B, and an operation classification table 22C.

In the organization table 22A, for example, information that defines the organization structure illustrated in A of FIG. 1 is stored. The organization table 22A of FIG. 8 includes organization IDs, organization names of organizations indicated by the organization IDs, and organization IDs of parent organizations for the organizations in the organization structure.

In the job classification table 22B, for example, information that defines job classifications in the job structure illustrated in B of FIG. 1 is stored. The job classification table 22B of FIG. 8 includes job IDs for identifying job classifications, job names of the job classifications indicated by the job IDs, and job IDs of parent jobs of the job classifications in the job structure.

In the operation classification table 22C, for example, information that defines operation classifications in the job structure illustrated in B of FIG. 1 is stored. The operation classification table 22C of FIG. 8 includes operation IDs for identifying operation classifications, operation names of the operation classifications indicated by the operation IDs, and job IDs indicative of parent jobs for the operation classifications in the job structure.

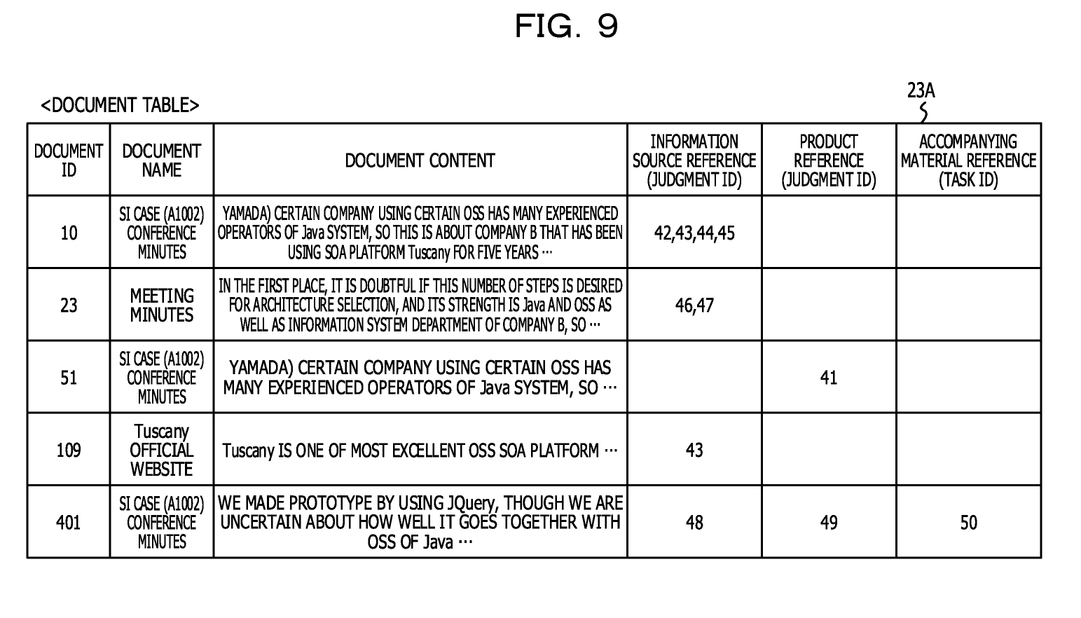

The document DB 23 includes, for example, a document table 23A illustrated in FIG. 9. The document table 23A of FIG. 9 includes document IDs, document names of documents indicated by the document IDs, and content of the documents. The document table 23A includes judgment IDs indicative of operation judgments 83 that reference the documents as information sources, judgment IDs indicative of operation judgments 83 that created the documents as products, and task IDs indicative of task logs 81 that specify the documents as accompanying materials.

As described above, the task log 81 includes an operation ID defined in the operation classification table 22C and an organization ID defined in the organization table 22A, and the disclosed range of each task log 81 is set in the disclosed range table 21C. These pieces of information make it possible to grasp the position of each task log 81 in the job structure and the organization structure, for example, as illustrated in FIG. 1.

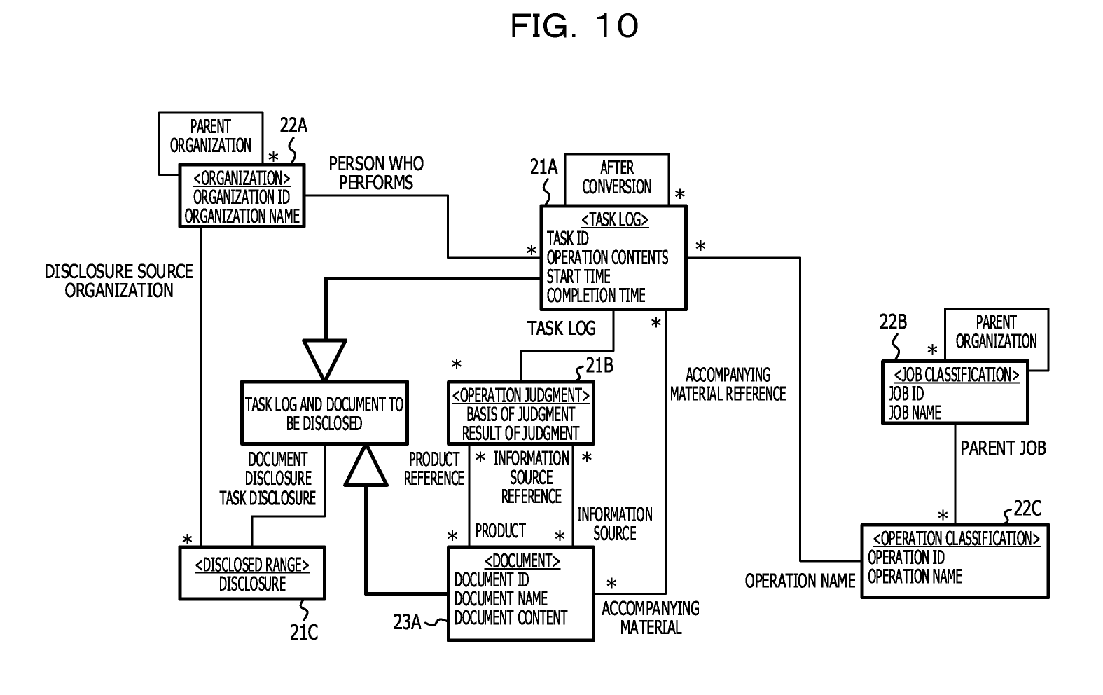

FIG. 10 illustrates a relationship among the tables stored in the task log DB 21, the job structure DB 22, and the document DB 23. In FIG. 10, table names in brackets (< >) and fields included in the tables are illustrated in the frames. A field of one table that is associated with a field of another table is described beside the other table that is connected to the one table by a line. The “*” sign indicates that a field of one table that is associated with a field of another table is also included in the table labeled with the “*” sign. A field of a table that refers to information in the same table is described outside of the frame of the table. “TASK LOG AND DOCUMENT TO BE DISCLOSED” indicates that a task log 81 and a document 82 to be disclosed are specified based on information of the disclosed range table 21C, the task log table 21A, and the document table 23A.

The masking section 11 acquires a task log 81 for which determining ease is to be calculated from the task log DB 21 and then extracts named entities from the acquired task log 81. The named entities are highly likely to be confidential information and are, for example, terms representing specific persons and specific organizations or terms related to specific persons and specific organizations such as organization names, personal names, place names, unique object names, date expressions, time expressions, money expressions, and percentage expressions. The masking section 11 performs a masking process such as blacking out the extracted named entities.

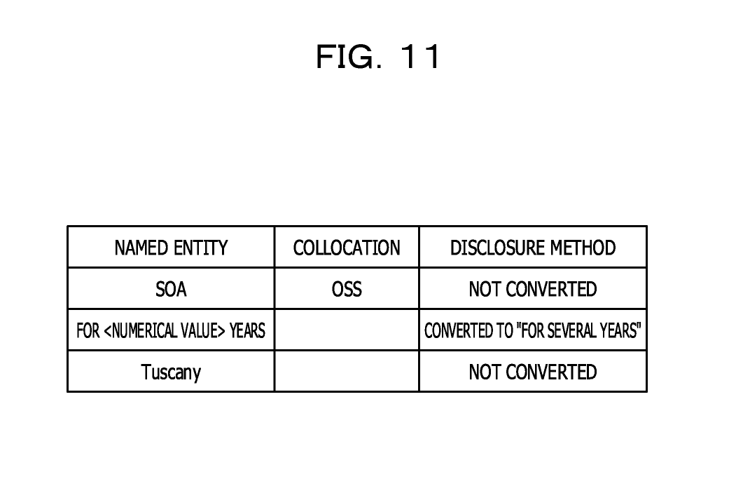

The masking section 11 receives an initial white list in which named entities that can be disclosed without masking and named entities that are subjected to a predetermined conversion process at the time of disclosure are defined in advance. FIG. 11 illustrates an example of a white list. In the example of FIG. 11, a named entity “Tuscany” can be disclosed without masking, and a named entity “<NUMERICAL VALUE> YEARS AGO” (a specific numerical value enters <numerical value>) is disclosed after conversion to “several years ago”. A named entity “SOA” can be disclosed only in a case of co-occurrence with “OSS” defined as a collocation. The masking section 11 omits or converts masked parts in the task log 81 in accordance with the white list. The masking section 11 assigns a new judgment ID to each operation judgment 83 after masking and assigns a new task ID to a task log 81 after masking.

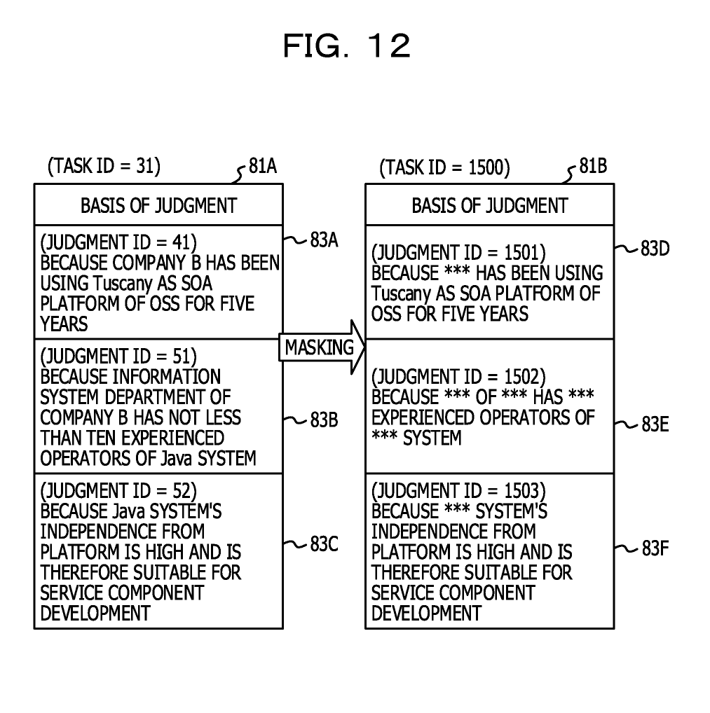

FIG. 12 illustrates an example of a task log 81A before masking and an example of a task log 81B after masking in a case where the white list in the example of FIG. 11 is used. FIG. 12 is an example in which operation judgments 83A, 83B, and 83C whose judgment IDs are 41, 51, and 52 respectively that are included in the task log 81A whose task ID is 31 are masked. The task log 81B after masking is given a task ID of 1500, and operation judgments 83D, 83E, and 83F are given judgment IDs of 1501, 1502, and 1503, respectively. In the example of FIG. 12, only “basis of judgment” of the operation judgment 83 in the task log 81 is illustrated. In the following description, only “basis of judgment” which is part of the task log 81 is sometimes referred to as a “task log 81”. Furthermore, description of individual “basis of judgment” is sometimes referred to as an “operation judgment 83”. Hereinafter, a masked named entity in the task log 81 after masking is referred to as a “non-disclosed expression”, and an unmasked named entity in the task log 81 is referred to as a “disclosed expression”.

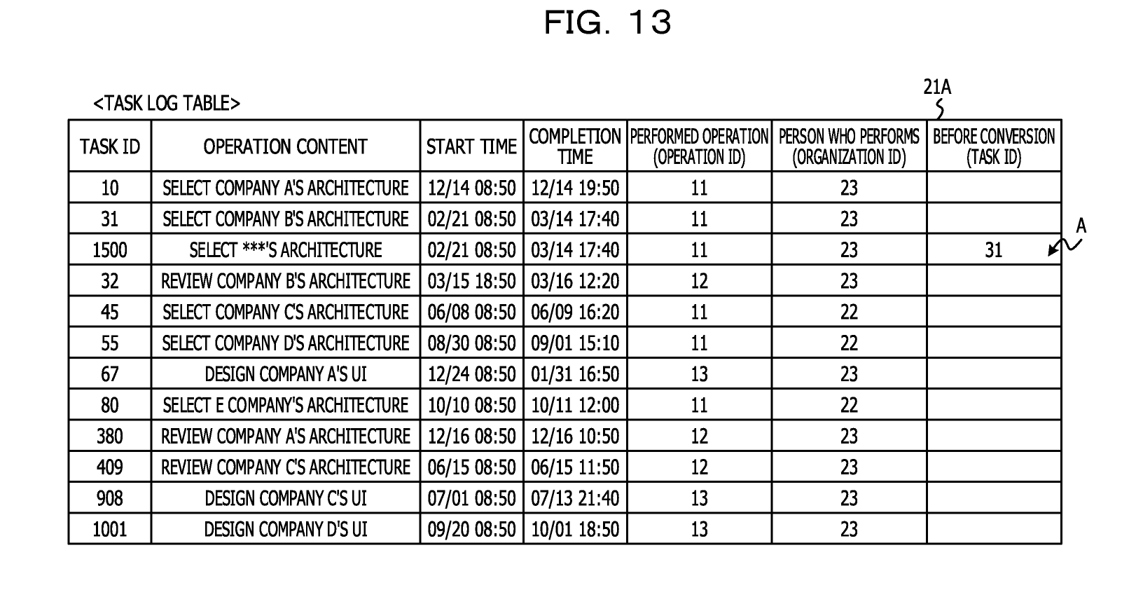

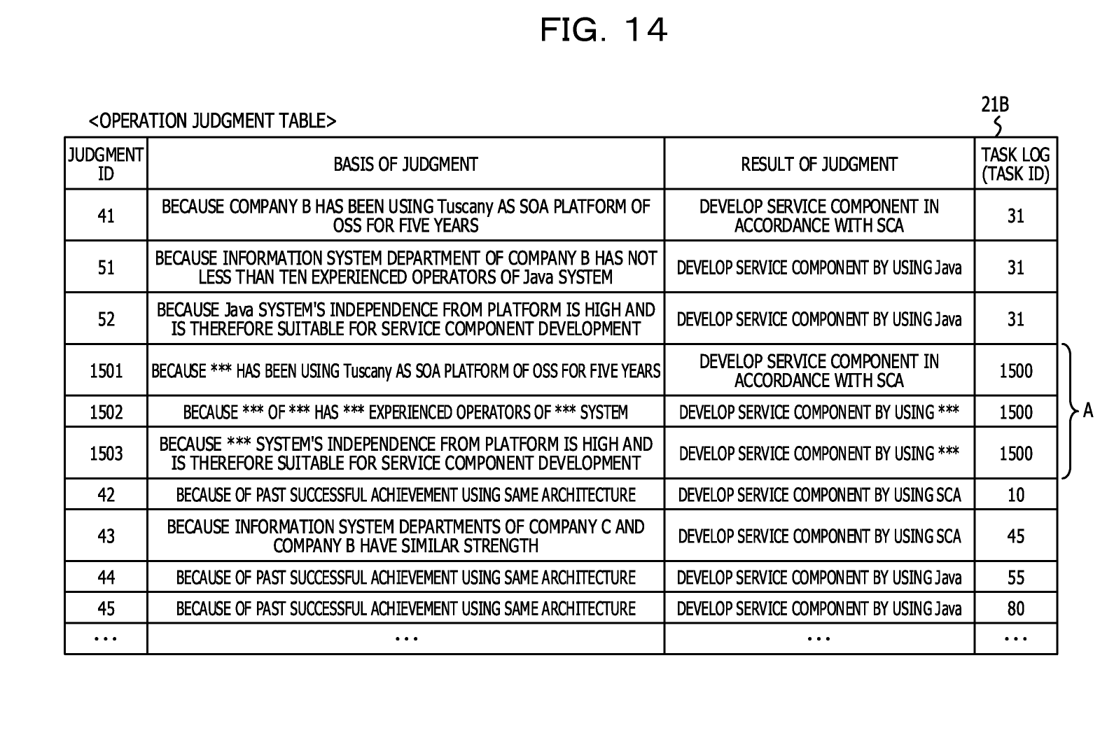

The masking section 11 adds the task log 81 after masking to the task log table 21A and adds the operation judgment 83 after masking to the operation judgment table 21B. FIG. 13 illustrates an example of the task log table 21A to which the task log 81B after masking in the example illustrated in FIG. 12 has been added. The row indicated by A in FIG. 13 has been added. The task ID of the task log 81 before masking that corresponds to the task log 81 after masking is registered in the field “BEFORE CONVERSION (TASK ID)” of the task log 81 after masking. FIG. 14 illustrates an example of the operation judgment table 21B to which the operation judgments 83D, 83E, and 83F after masking in the example illustrated in FIG. 12 have been added. The rows indicated by A in FIG. 14 have been added. The task ID given to the task log including the operation judgments 83 after masking is registered in the field “TASK LOG (TASK ID)” of the operation judgment 83 after masking.

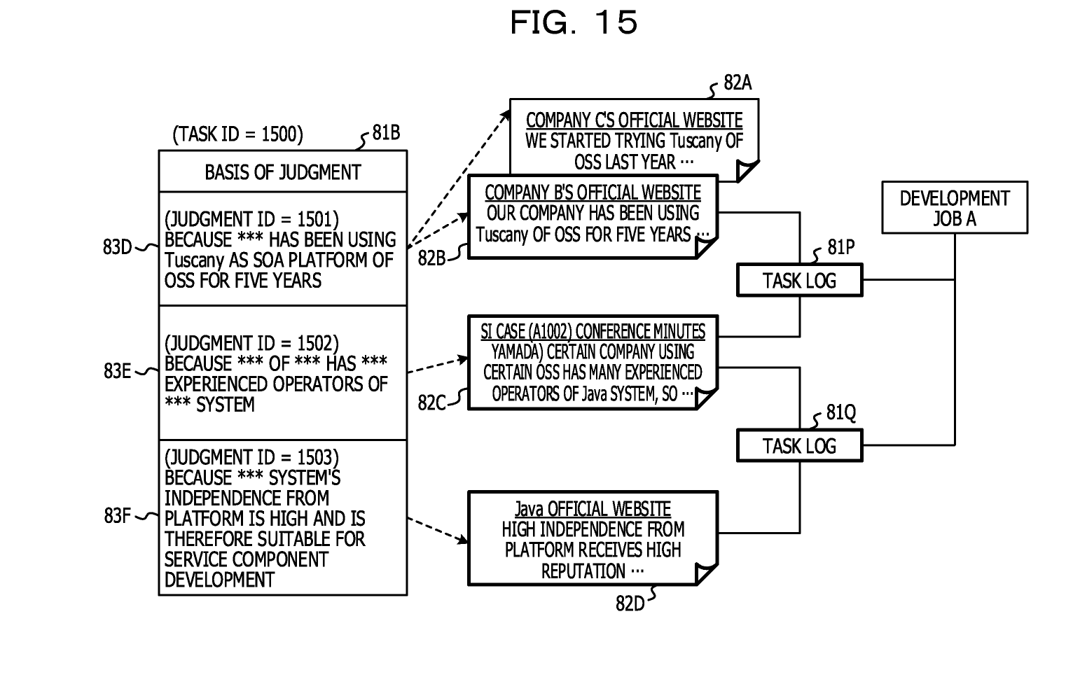

It is assumed here that, for example, documents 82A and 82B concerning Company B and Company C are retrieved from the disclosed expressions “OSS” and “Tuscany” described in the operation judgment 83D after masking whose judgment ID is 1501, as illustrated in FIG. 15. In this case, a non-disclosed expression in the operation judgment 83D has “2-anonymity”. That is, the possibility of identification of the non-disclosed expression in the operation judgment 83D is 50%.

However, the following considers, for example, a plurality of document 82 including documents 82C and 82D that are retrieved based on the disclosed expressions in the operation judgment 83E whose judgment ID is 1502 and the operation judgment 83F whose judgment ID is 1503. It is assumed that the three documents 82B, 82C, and 82D including the disclosed document of Company B are, for example, documents referred to in task logs 81P and 81Q concerning a job “DEVELOPMENT JOB A”. In this case, masked parts can be determined by combining these three documents 82B, 82C, and 82D. In the example of FIG. 15, by comparing these three documents 82B, 82C, and 82D, the content “Company B constructs the SOA platform by using Tuscany and develops a service component by using Java (Registered Trademark)” can be determined.

As described above, even in a case where there are a plurality of documents 82 that are retrieved based on disclosed expressions in a task log 81 after masking and when it seems difficult to determine non-disclosed expressions by using an index such as k-anonymity, it is sometimes possible to narrow down combinations of documents 82. That is, there is a case where determining non-disclosed expressions is easier than indicated by an index such as k-anonymity. Considering that determining based on a combination of documents 82 is easier than indicated by an index such as k-anonymity, an index indicating that determining is easier is desired.

In view of this, in the present embodiment, the ease of determining that takes into consideration ease of determining based on a combination of documents 82 is calculated. The calculating section 12 that calculates determining ease is described in detail below.

As illustrated in FIG. 4, the calculating section 12 includes a transition possibility calculating section 13, an identification possibility calculating section 14, a relevance calculating section 15, a determining ease calculating section 16, and a readability calculating section 17.

The transition possibility calculating section 13 calculates a transition possibility indicative of the possibility of transition of determining of a non-disclosed expression from determining based on one document 82 to determining based on another document 82 among a plurality of documents 82 retrieved based on disclosed expressions in a task log 81 after masking. In the present embodiment, the transition possibility calculating section 13 calculates the transition possibility assuming that the transition possibility increases (transition is easier) as the number of non-disclosed expressions common to operation judgments 83 increases.

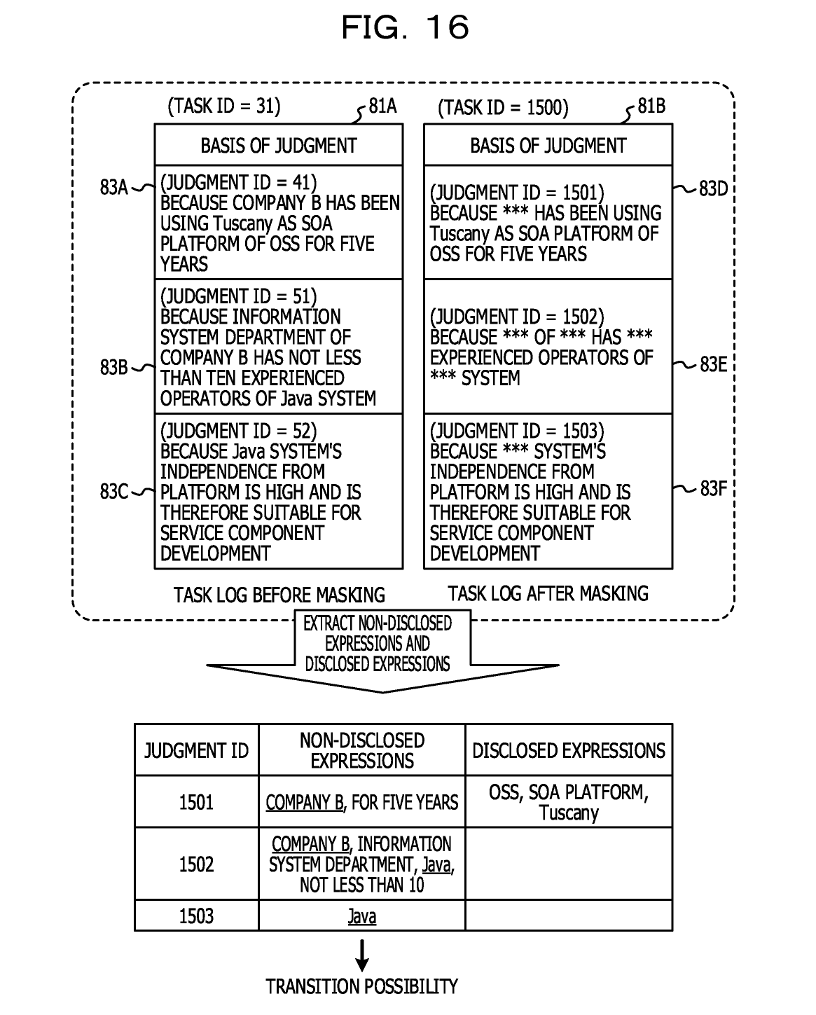

Specifically, the transition possibility calculating section 13 acquires, from the task log table 21A, a task log 81 after masking for which determining ease is to be calculated. Furthermore, the transition possibility calculating section 13 acquires a corresponding task log 81 before masking that is identified by a task ID registered in the field “BEFORE CONVERSION (TASK ID)” of the acquired task log 81 after masking. As illustrated in FIG. 16, the transition possibility calculating section 13 extracts, for each operation judgment 83, non-disclosed expressions and disclosed expressions based on the acquired task log 81A before masking and the acquired task log 81B after masking. The non-disclosed expressions can be extracted by identifying named entities in the task log 81A before masking that correspond to masked parts in the task log 81B after masking. The disclosed expressions can be extracted by identifying unmasked named entities included in the task log 81B after masking. The transition possibility calculating section 13 calculates, for example, the transition possibility expressed by the following equation (1) based on the extracted non-disclosed expressions.

$$transition possibility = {\sum }_{w ∈ non - disclosed expressions} \frac{\vert \{ operation judgment \vert w ∈ operation judgment \} \vert}{\vert \{ operation judgment \} \vert} \qquad ( 1 )$$

The equation (1) expresses the sum of ratios, calculated for all of the non-disclosed expressions, of the number of operation judgments 83 including a non-disclosed expression to the total number of operation judgments 83 included in the task log 81 after masking. In the example of FIG. 16, the task log 81B after masking includes three operation judgments 83D, 83E, and 83F whose judgment IDs are 1501, 1502, and 1503, respectively, and includes five (five types of) non-disclosed expressions in total. Among these non-disclosed expressions, a non-disclosed expression “Company B” is included in two operation judgments 83D and 83E, and a non-disclosed expression “Java (Registered Trademark)” is included in two operation judgments 83E and 83F. A non-disclosed expression “five years ago” is included only in a single operation judgment 83D, and each of non-disclosed expressions “information system department” and “ten or more persons” is included only in a single operation judgment 83E. Therefore, the transition possibility is calculated in accordance with the equation (1) as follows:

transition possibility=⅔+⅔+⅓+⅓+⅓=2.33

The identification possibility calculating section 14 calculates an identification possibility indicative of the possibility of identification of a combination of documents 82 from which non-disclosed expressions can be determined among a plurality of documents 82 retrieved based on disclosed expressions in a task log 81 after masking. In the present embodiment, the identification possibility calculating section 14 calculates the identification possibility assuming that the identification possibility increases (identification is easier) as the number of documents including a non-disclosed expression among the documents retrieved based on the disclosed expressions increases.

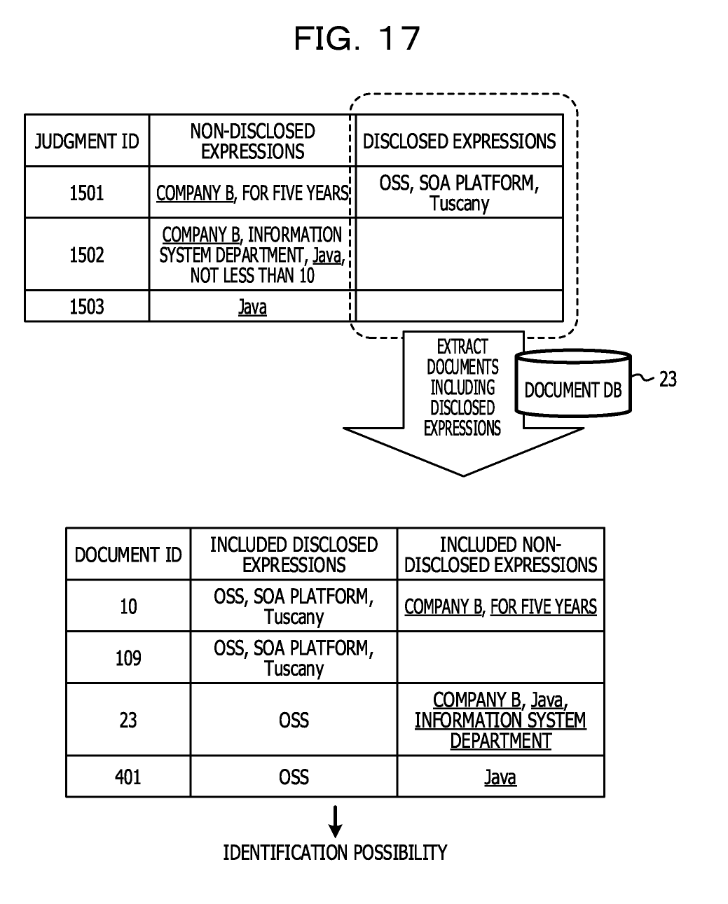

Specifically, as illustrated in FIG. 17, the identification possibility calculating section 14 extracts, for each operation judgment 83, a document including a disclosed expression from the document DB 23 by using information of disclosed expressions of the operation judgment 83 extracted by the transition possibility calculating section 13. The identification possibility calculating section 14 calculates, for example, the identification possibility expressed by the following equation (2) based on the extracted document.

$$identification possibility = {\prod }_{i ∈ operation judgment including disclosed expressions} \frac{ \begin{matrix}the number of documents including \\ non \text{-} disclosed expressions of i\end{matrix}}{\begin{matrix}the number of documents including \\ disclosed expressions of i\end{matrix}} \qquad ( 2 )$$

In the example of FIG. 17, the operation judgment 83 whose judgment ID is 1501 includes disclosed expressions, and four documents 82 whose document IDs are 10, 109, 23, and 401 are extracted based on the disclosed expressions. Of the four documents 82, two documents whose document IDs are 10 and 23 include non-disclosed expressions included in the operation judgment 83 whose judgment ID is 1501. Therefore, the identification possibility is calculated in accordance with the equation (2) as follows:

identification possibility= 2/4=0.50

The relevance calculating section 15 calculates relevance, in a job structure, among a plurality of documents 82 retrieved based on disclosed expressions in a task log 81 after masking. The relevance between documents is higher in a case where the documents are related to an identical job or as the relevance between jobs to which the documents are related increases. In a case where the relevance between documents is high, the possibility of using a combination of these documents 82 for determining is high. In the present embodiment, the relevance between documents is expressed by a distance on the job structure between task logs 81 corresponding to the documents. A shorter distance between the task logs 81 means a higher relevance between the documents.

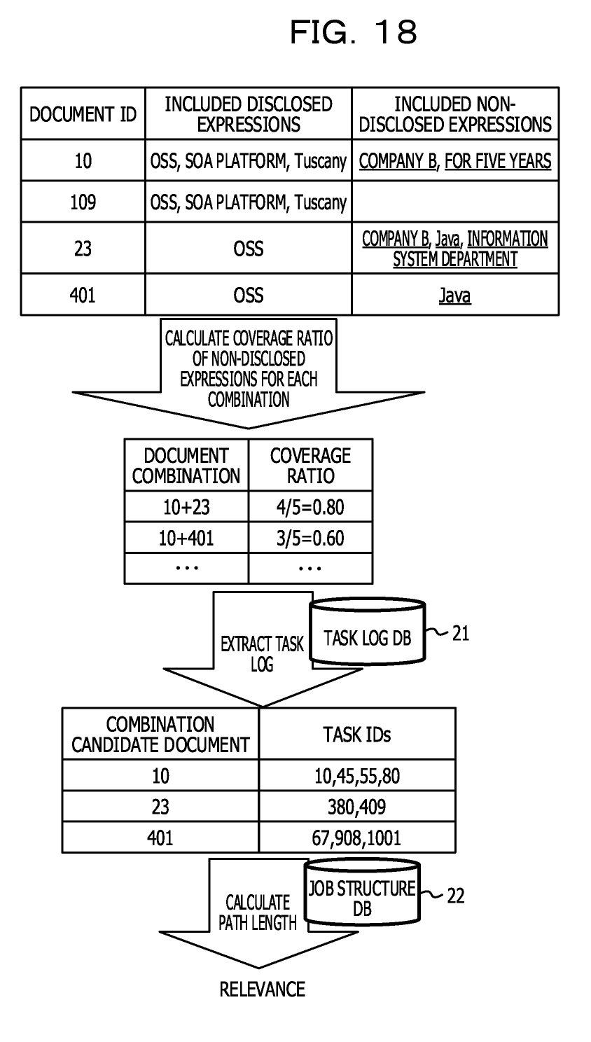

Specifically, as illustrated in FIG. 18, the relevance calculating section 15 calculates, for all combinations of the documents 82 extracted by the identification possibility calculating section 14, a coverage ratio indicative of a ratio of the number of non-disclosed expressions included in both documents 82 to the total number of non-disclosed expressions extracted by the transition possibility calculating section 13. For example, as illustrated in FIG. 16, it is assumed that five non-disclosed expressions are extracted from all of the operation judgments 83 and the four documents 82 illustrated in FIG. 17 are extracted. In this case, for example, the number of non-disclosed expressions included in the document 82 whose document ID is 10 and the document 82 whose document ID is 23 is four. Accordingly, the coverage ratio for the combination of the document 82 whose document ID is 10 and the document 82 whose document ID is 23 is ⅘=0.80.

The relevance calculating section 15 extracts a combination of documents 82 whose coverage ratio, which is calculated for each combination of documents 82, is equal to or higher than a threshold value. The relevance calculating section 15 regards each of the documents 82 that constitute the extracted combination of documents 82 as a combination candidate document and extracts, for each combination candidate document, a task ID of a task log 81 that refers to the combination candidate document as an information source or a product from the task log DB 21. Specifically, a case where a task ID of a task log 81 that refers to the document 82 whose document ID is 10 as an example of the combination candidate document is described. First, the document 82 whose document ID is 10 is retrieved from the document table 23A, and then judgment IDs registered in the fields “INFORMATION SOURCE REFERENCE (JUDGMENT ID)” and “PRODUCT REFERENCE (JUDGMENT ID)” of the document 82 whose document ID is 10 are extracted. Next, a task ID registered in the field “TASK LOG (TASK ID)” of the operation judgment table 21B is extracted for each of the extracted judgment IDs.

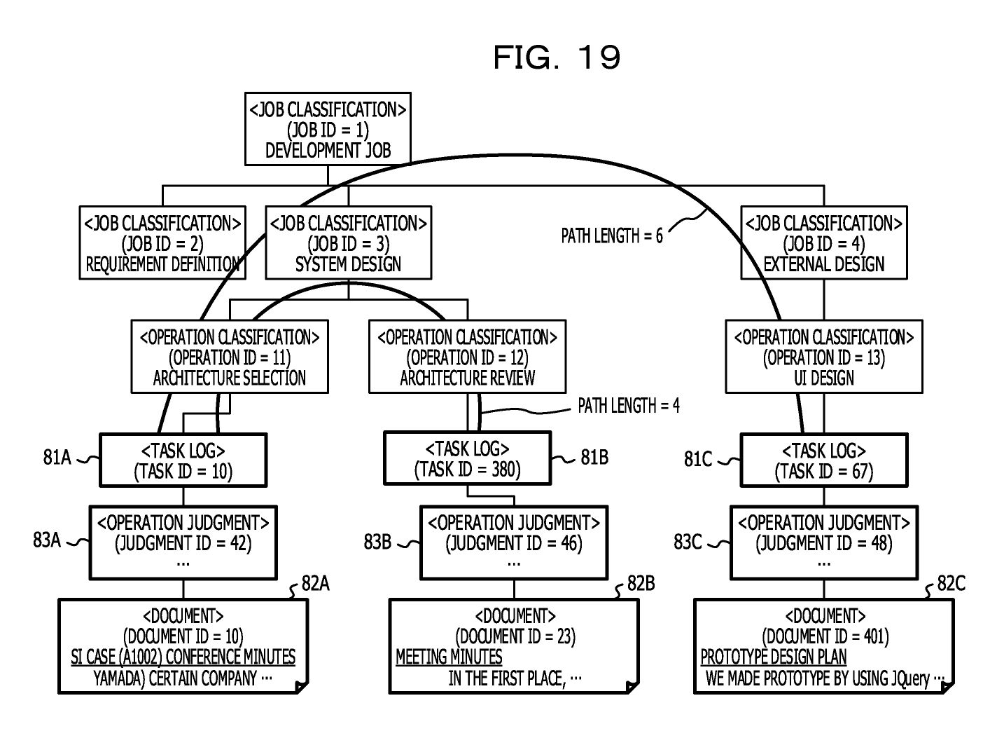

The relevance calculating section 15 obtains, for each extracted combination of documents 82, a minimum path length between task logs corresponding to both documents 82 in the job structure. For example, as illustrated in FIG. 19, each operation classification is associated with a job classification indicated by a job ID registered in the field “PARENT JOB (JOB ID)” of the operation classification table 22C. A relationship between job classifications is determined by a parent-child relationship with a job classification having a job ID registered in the field “PARENT JOB (JOB ID)” of the job classification table 22B. Meanwhile, in the task log table 21A, the operation ID of 11 is registered in the field “PERFORMED OPERATION (OPERATION ID)” of the task log 81 whose task ID is 10. That is, as illustrated in FIG. 19, the task log 81 whose task ID is 10 is associated with an operation classification whose operation ID is 11 (operation name “ARCHITECTURE SELECTION”). Accordingly, it is possible to specify the position, on the job structure, of a task log 81 indicated by a task ID extracted based on a document ID as described above.

Specifically, the relevance calculating section 15 extracts, for each extracted combination of documents 82, a combination of task logs 81 indicated by task IDs extracted for each combination candidate document. The relevance calculating section 15 specifies, for each extracted combination of task logs 81, the positions, on the job structure, of two task logs 81 that constitute the combination. Then, the number of nodes that are traced from the task logs 81 to a node of a higher-level job structure common to the task logs 81 through nodes indicative of operation classifications and nodes indicative of job classifications is obtained as a path length. For example, in the example of FIG. 19, the path length of a path connecting the task log 81A whose task ID is 10 and the task log 81B whose task ID is 380 is “4”. The path length between the task log 81A whose task ID is 10 and the task log 81C whose task ID is 67 is “6”. The relevance calculating section 15 determines one of the path lengths of combinations of task logs 81 extracted for each combination of documents 82 as a minimum path length of the combination of documents 82.

As illustrated in FIG. 19, in a case where the job structure is expressed by a tree structure, a shorter path length between task logs 81 means a higher relevance between jobs. In view of this, the relevance calculating section 15 calculates, for example, the relevance by the following equation (3) by using the minimum path length obtained for each extracted combination of documents 82.

$$relevance = {Max}_{d ∈ combination of documents} ( α , 1 - \frac{minimum path length of d}{average length of all paths on work structure} ) \qquad ( 3 )$$

In the equation (3), α is an invariable that defines a lower limit value of the relevance and is, for example, set to a value such as “0.1” in advance. The value of the relevance expressed by the equation (3) is larger as the minimum path length obtained for each combination of documents 82 is shorter, i.e., as the relevance between jobs is higher.

The determining ease calculating section 16 calculates determining ease by uniting the transition possibility calculated by the transition possibility calculating section 13, the identification possibility calculated by the identification possibility calculating section 14, and the relevance calculated by the relevance calculating section 15. For example, the determining ease calculating section 16 can calculate, as the value of determining ease, a value obtained by multiplying together the values of the transition possibility, the identification possibility, and the relevance, the weighted sum of the values of the transition possibility, the identification possibility, and the relevance, or the like. Alternatively, the determining ease may be calculated by using a probability model with an assumed determining process.

The readability calculating section 17 calculates, as an indication of readability, a ratio of the number of disclosed expressions to the total number of named entities included in a target task log 81.

The changing section 18 creates white list replacement candidates by replacing, with disclosed expressions, named entities that are set as non-disclosed expressions in the initial white list among the named entities included in the target task log 81. Furthermore, the changing section 18 creates white list replacement candidates by removing named entities that are set as disclosed expressions in the initial white list among the named entities included in the target task log 81. The changing section 18 instructs the masking section 11 to perform a masking process with respect to the target task log 81 based on the white list replacement candidates. Furthermore, the changing section 18 instructs the calculating section 12 to calculate determining ease and readability of task logs 81 of respective patterns that have been subjected to the masking process based on the white list replacement candidates.

The masking section 11 and the calculating section 12 perform the masking process and the process of calculating determining ease and readability based on the white list replacement candidates in response to an instruction from the changing section 18 in a similar manner to the processes executed based on the initial white list. In executing the masking process, the masking section 11 associates, with the task logs 81 of the respective patterns that have been subjected to the masking process based on the white list replacement candidates, the task ID of the task log 81 that has been subjected to the masking process based on the initial white list. Then, the task logs 81 of the respective patterns are stored in a predetermined storage region together with the associated task ID and pattern information indicating which patterns the task logs 81 have and which white list replacement candidates were used in the masking process. Furthermore, determining ease and readability calculated for the task logs 81 of the respective patterns by the calculating section 12 are also associated with the task logs 81 of the respective patterns and stored in the predetermined storage region.

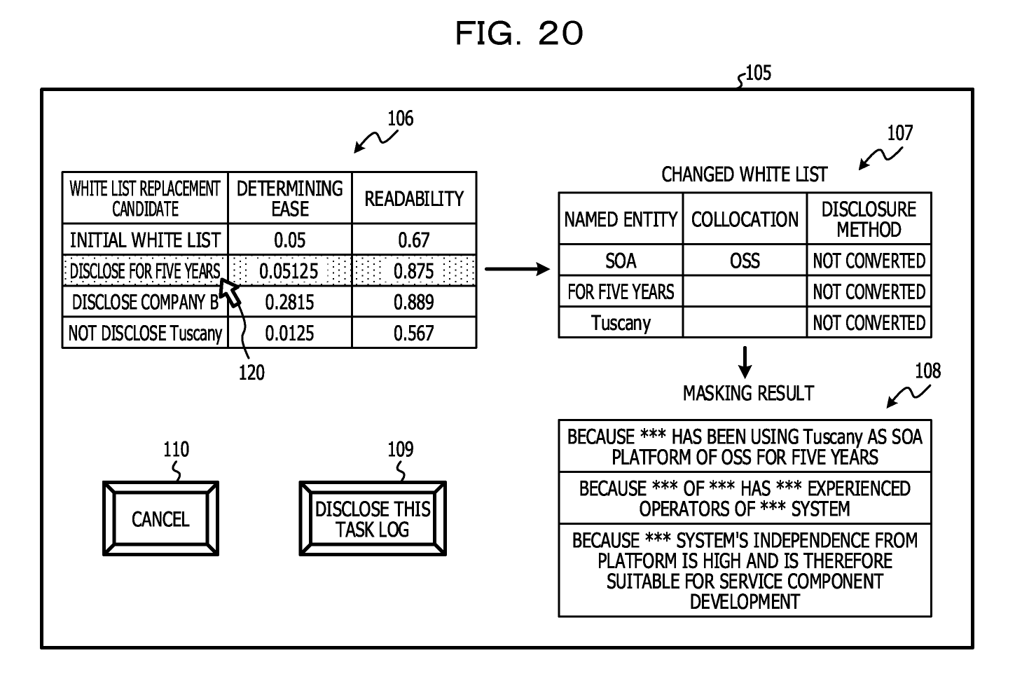

Furthermore, the changing section 18 presents, for example, to the administrator of the workflow system 200, the task log 81 that has been subjected to the masking process based on the initial white list by the masking section 11 and the determining ease and the readability calculated for the task log 81 by the calculating section 12. Furthermore, the changing section 18 presents the white list replacement candidates and the values of the determining ease and readability calculated for the corresponding task logs 81 of the respective patterns in such a manner that one white list replacement candidate is selectable by the administrator. For example, the changing section 18 causes a display screen 105 illustrated in FIG. 20 to be displayed on a display device available to the administrator.

The display screen 105 illustrated in FIG. 20 includes a replacement list display region 106, a changed content display region 107, a result display region 108, a setting button 109, and a cancel button 110. In the replacement list display region 106, a list of the initial white list and the white list replacement candidate and the values of determining ease and readability of the corresponding task logs 81 of the respective patterns is displayed. Note that the replacement candidates displayed in the replacement list display region 106 may be limited to ones whose determining ease calculated for corresponding task logs 81 of the respective patterns is equal to or lower than a predetermined upper limit value and whose readability calculated for the corresponding task logs 81 of the respective patterns is equal to or higher than a predetermined lower limit value. The administrator selects one replacement candidate, for example, by pointing a cursor 120 to the one replacement candidate from among the white list replacement candidates displayed in the replacement list display region 106 in consideration of the values of determining ease and readability.

In the changed content display region 107, a changed white list to which the content of the replacement candidate selected from the list displayed in the replacement list display region 106 have been applied is displayed. The initial state of the display screen 105 may be a state in which the initial white list is being selected. In the result display region 108, a task log 81 that has been subjected to the masking process based on the white list displayed in the changed content display region 107 is displayed.

The setting button 109 is a button selected in a case where the task log 81 displayed in the result display region 108 is disclosed. The cancel button 110 is a button selected in a case where the task log displayed in the result display region 108 is not disclosed.

The changing section 18 adopts, as a task log 81 after masking to be disclosed, the task log 81 displayed in the result display region 108 when the setting button 109 on the presented display screen 105 is selected, for example, by the administrator and notifies the managing section 19 of the adopted task log 81. In a case where the adopted task log 81 is a task log 81 based on the initial white list, the changing section 18 notifies the managing section 19 of the task ID. Meanwhile, in a case where the adopted task log 81 is a task log 81 having a pattern based on any one of the white list replacement candidates, the changing section 18 notifies the managing section 19 of pattern information indicative of the pattern of the task log 81 together with the task ID.

Upon notification of the pattern information together with the task ID from the changing section 18, the managing section 19 acquires the task log 81 having the pattern indicated by the pattern information from the predetermined storage region. Then, the managing section 19 updates parts corresponding to the notified task ID in the task log table 21A and the operation judgment table 21B with the acquired content of the task log 81. Accordingly, information of the adopted task log 81 is stored in the task log DB 21.

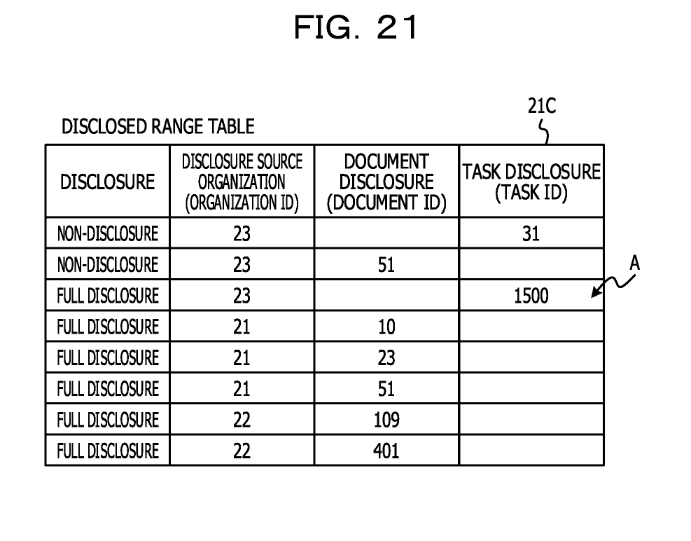

The managing section 19 records, in the disclosed range table 21C, setting information for disclosing the adopted task log 81. Specifically, as illustrated in FIG. 21, the managing section 19 adds a row (A in FIG. 21) in which the field “DISCLOSURE” is set to “FULL DISCLOSURE” to the disclosed range table 21C and registers the notified task ID in the field “TASK DISCLOSURE (TASK ID)”. Furthermore, the managing section 19 acquires an organization ID registered in the field “PERSON WHO PERFORMS (ORGANIZATION ID)” of the task log 81 of the notified task ID from the task log table 21A and registers the acquired organization ID in the field “DISCLOSURE SOURCE ORGANIZATION (ORGANIZATION ID)” of the disclosed range table 21C.

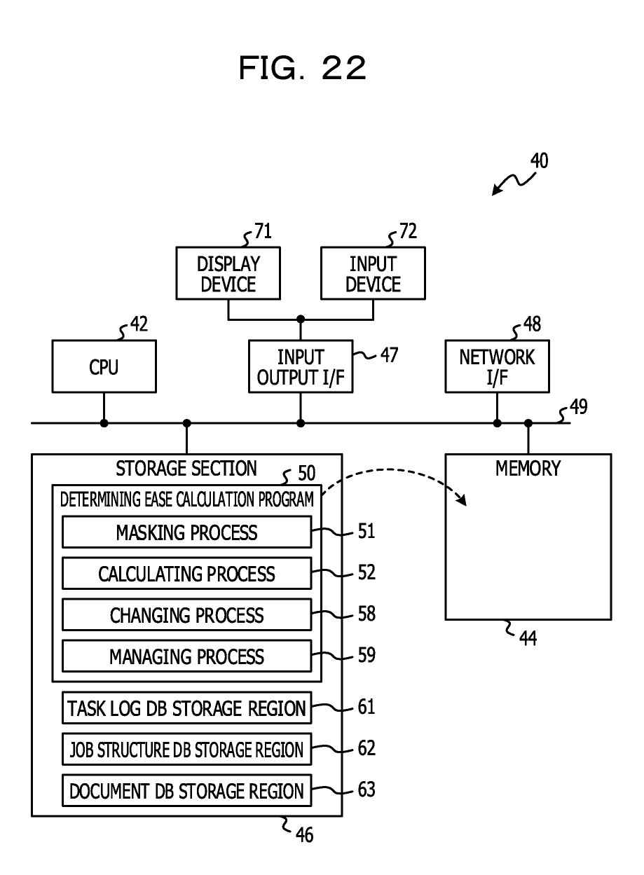

The determining ease calculating device 10 can be realized, for example, by a computer 40 illustrated in FIG. 22. The computer 40 includes a CPU 42, a memory 44, a non-volatile storage section 46, an input output interface (I/F) 47, and a network I/F 48. The CPU 42, the memory 44, the storage section 46, the input output I/F 47, and the network I/F 48 are connected to each other via a bus 49.

The computer 40 is connected to a display device 71 such as a display and an input device 72 such as a mouse and a keyboard via the input output I/F 47. On the display device 71, the display screen 105 illustrated in FIG. 16 is displayed, and the administrator inputs various kinds of selection information by operating the input device 72. Note that display on the display screen 105 and input of the selection information may be performed on a personal computer or the like connected via the network I/F 47 over a network.

The storage section 46 can be realized by a hard disk drive (HDD), a solid state drive (SSD), a flash memory, or the like. In the storage section 46, which serves as a storage medium, a determining ease calculation program 50 for causing the computer 40 to function as the determining ease calculating device 10 is stored. The storage section 46 includes a task log DB storage region 61 in which information that constitutes the task log DB 21 is stored, a job structure DB storage region 62 in which information that constitutes the job structure DB 22 is stored, and a document DB storage region 63 in which information that constitutes the document DB 23 is stored. The CPU 42 reads the determining ease calculation program 50 out from the storage section 46, loads the determining ease calculation program 50 to the memory 44, and then sequentially executes processes of the determining ease calculation program 50. Furthermore, the CPU 42 reads out information stored in the task log DB storage region 61, the job structure DB storage region 62, and the document DB storage region 63 and loads the information to the memory 44 as tables that constitute the task log DB 21, the job structure DB 22, and the document DB 23.

The determining ease calculation program 50 has a masking process 51, a calculating process 52, a changing process 58, and a managing process 59. The CPU 42 operates as the masking section 11 illustrated in FIG. 4 by executing the masking process 51. The CPU 42 operates as the calculating section 12 illustrated in FIG. 4 by executing the calculating process 52. The CPU 42 operates as the changing section 18 illustrated in FIG. 4 by executing the changing process 58. The CPU 42 operates as the managing section 19 illustrated in FIG. 4 by executing the managing process 59. Thus, the computer 40 that executes the determining ease calculation program 50 functions as the determining ease calculating device 10.

Note that the determining ease calculating device 10 can also be realized, for example, by a semiconductor integrated circuit, more specifically an application specific integrated circuit (ASIC) or the like.

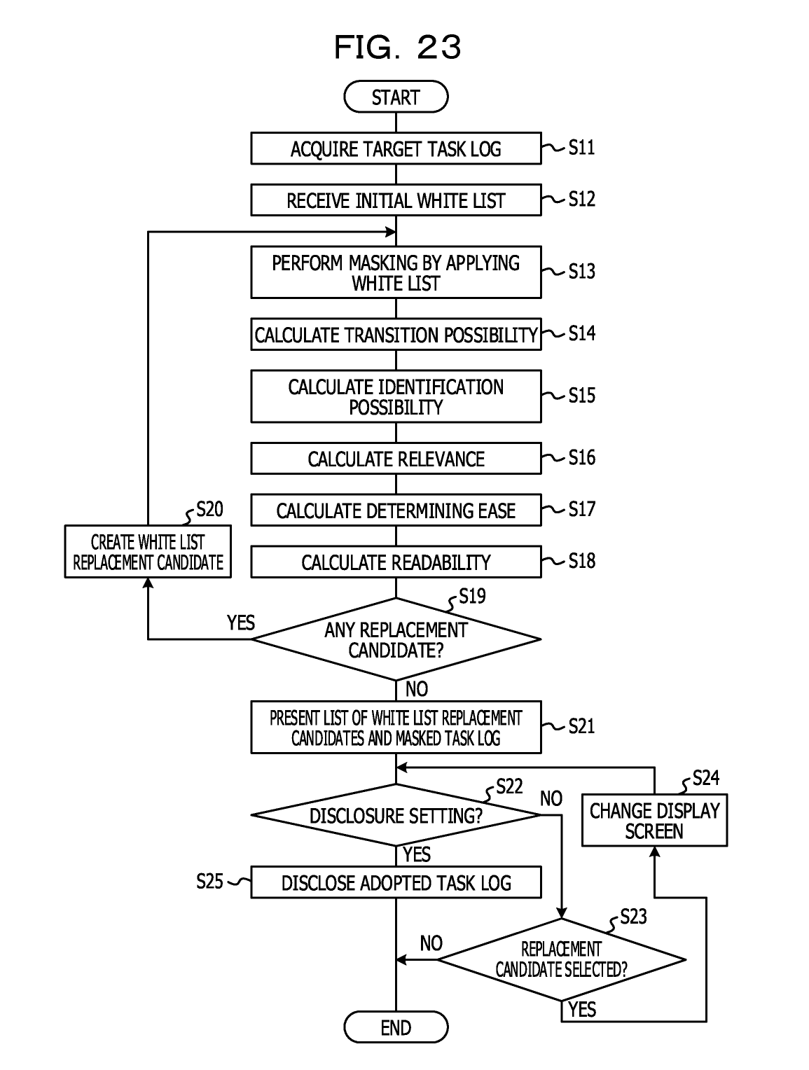

Next, the following describes how the determining ease calculating device 10 according to the present embodiment jobs. In the determining ease calculating device 10, a determining ease calculating process illustrated in FIG. 23 is executed.

In Step S11 of the determining ease calculating process illustrated in FIG. 23, the masking section 11 acquires a target task log 81 for which determining ease is to be calculated from the task log DB 21. Next, in Step S12, the masking section 11 receives an initial white list.

Next, in Step S13, the masking section 11 extracts named entities from the acquired task log 81 and performs a masking process with respect to the target task log 81 based on the received initial white list. The masking section 11 gives the task log 81 after masking a new task ID and adds the task log 81 to the task log table 21A. Furthermore, the masking section 11 gives each operation judgment 83 after masking a new judgment ID and adds the operation judgment 83 to the operation judgment table 21B.

Next, in Step S14, the transition possibility calculating section 13 extracts, for each operation judgment 83, non-disclosed expressions and disclosed expressions based on the task log 81 before masking and the task log 81 after masking. Then, the transition possibility calculating section 13 calculates, for example, a transition possibility expressed by the equation (1) based on the extracted non-disclosed expressions.

Next, in Step S15, the identification possibility calculating section 14 extracts, for each operation judgment 83, documents 82 including the disclosed expressions from the document DB 23 by using information of the disclosed expressions extracted for each operation judgment 83 in Step S14. Then, the identification possibility calculating section 14 calculates, for example, an identification possibility expressed by the equation (2) based on the extracted documents 82.

Next, in Step S16, the relevance calculating section 15 calculates, for all combinations of documents 82 extracted in Step S15, a coverage ratio which is a ratio of the number of non-disclosed expressions included in both documents 82 to the total number of non-disclosed expressions extracted in Step S14. Then, the relevance calculating section 15 extracts a combination of documents 82 whose coverage ratio, which is calculated for each combination of documents 82, is equal to or higher than a predetermined threshold value. Furthermore, the relevance calculating section 15 extracts, from the task log DB 21, task IDs of task logs 81 that refer to the documents that constitute the extracted combination of documents 82 as an information source or a product. Then, the relevance calculating section 15 obtains, for each extracted combination of documents 82, a minimum path length between the task logs 81 corresponding to both documents 82 in the job structure and calculates, for example, relevance expressed by the equation (3).

Next, in Step S17, the determining ease calculating section 16 calculates determining ease by unifying the transition possibility calculated in Step S14, the identification possibility calculated in Step S15, and the relevance calculated in Step S16. Next, in Step S18, the readability calculating section 17 calculates, as readability, a ratio of the number of disclosed expressions to the total number of named entities included in the target task log 81.

Next, in Step S19, the changing section 18 determines whether or not there is a white list replacement candidate that can be created. In a case of YES, the processing proceeds to Step S20. In Step S20, the changing section 18 creates a white list replacement candidate by replacing, with disclosed expressions, named entities that are set as non-disclosed expressions in the initial white list among the named entities included in the target task log 81. Alternatively, the changing section 18 creates a white list replacement candidate by removing named entities that are set as disclosed expressions in the initial white list among the named entities included in the target task log 81.

Next, the processing returns to Step S13, and the processes in Steps S13 through S18 are repeated based on the white list replacement candidate created in Step S20. In Step S13, the masking section 11 causes the task log 81 that has been masked based on the white list replacement candidate to be stored in a predetermined storage region without adding the task log 81 to the task log table 21A and the operation judgment table 21B. After all of the white list replacement candidates have been created, it is determined in Step S19 that there is no white list replacement candidate that can be created. Then, the processing proceeds to Step S21.

In Step S21, the changing section 18 causes, for example, the display screen 105 illustrated in FIG. 20 to be displayed on a display device that is available to an administrator. The changing section 18 displays, in the replacement list display region 106 of the display screen 105, a list of the initial white list, the white list replacement candidates, and values of determining ease and readability calculated for corresponding task logs 81 of respective patterns. The changing section 18 displays the list in such a manner that the initial white list is being selected. Furthermore, the changing section 18 displays the initial white list in the changed content display region 107. Furthermore, the changing section 18 displays, in the result display region 108, the task log 81 that has been subjected to the masking process based on the initial white list.

When the administrator inputs selection information in accordance with the display screen 105, the changing section 18 determines in Step S22 whether or not the input selection information is selection information for which the setting button 109 has been selected. In a case where NO in Step S22, the processing proceeds to Step S23, in which the changing section 18 determines whether or not the input selection information is selection information for selecting the white list replacement candidate. In a case where YES in Step S22, the processing proceeds to Step S24, in which the changing section 18 changes the content displayed in the changed content display region 107 and the result display region 108 based on the selected white list replacement candidate. Then, the processing returns to Step S22. In a case where it is determined in Step S22 that the input selection information is selection information for which the setting button 109 has been selected, the processing proceeds to Step S25.

In Step S25, the changing section 18 adopts, as a task log 81 after masking to be disclosed, a task log 81 displayed in the result display region 108 when the setting button 109 is selected. The changing section 18 notifies the managing section 19 of the task ID in a case where the adopted task log 81 is a task log 81 based on the initial white list. Meanwhile, in a case where the adopted task log 81 is a task log 81 having a pattern based on any one of the white list replacement candidates, the changing section 18 notifies the managing section 19 of information indicative of the pattern of the task log 81 together with the task ID. Then, in a case where the managing section 19 is notified of the information indicative of the pattern of the task log 81 together with the task ID by the changing section 18, the managing section 19 acquires the task log 81 having the pattern indicated by the pattern information from the predetermined storage region. Then, in the task log DB 21, a part corresponding to the notified task ID is updated with the content of the acquired task log 81. Furthermore, the managing section 19 records, in the disclosed range table 21C, setting information for disclosing the adopted task log. Then, the determining ease calculating process is finished.

Meanwhile, in a case of NO in Step S23, it is determined that the cancel button 110 has been selected, and the determining ease calculating process is finished without disclosure setting of the target task log 81.

As described above, according to the determining ease calculating device 10 according to the present embodiment, a masking process is performed with respect to confidential information in a task log for a task performed in accordance with a workflow system that is constructed in accordance with a job structure. Furthermore, relevance of a plurality of combinations of documents retrieved based on disclosed expressions in a task log after masking is calculated based on relevance, in the job structure, of task logs that refer to these documents. Furthermore, determining ease of non-disclosed expressions in the task log after masking is calculated by using the calculated relevance of the combinations of documents. It is therefore possible to calculate determining ease taking into consideration a combination of documents used to determine non-disclosed expressions.

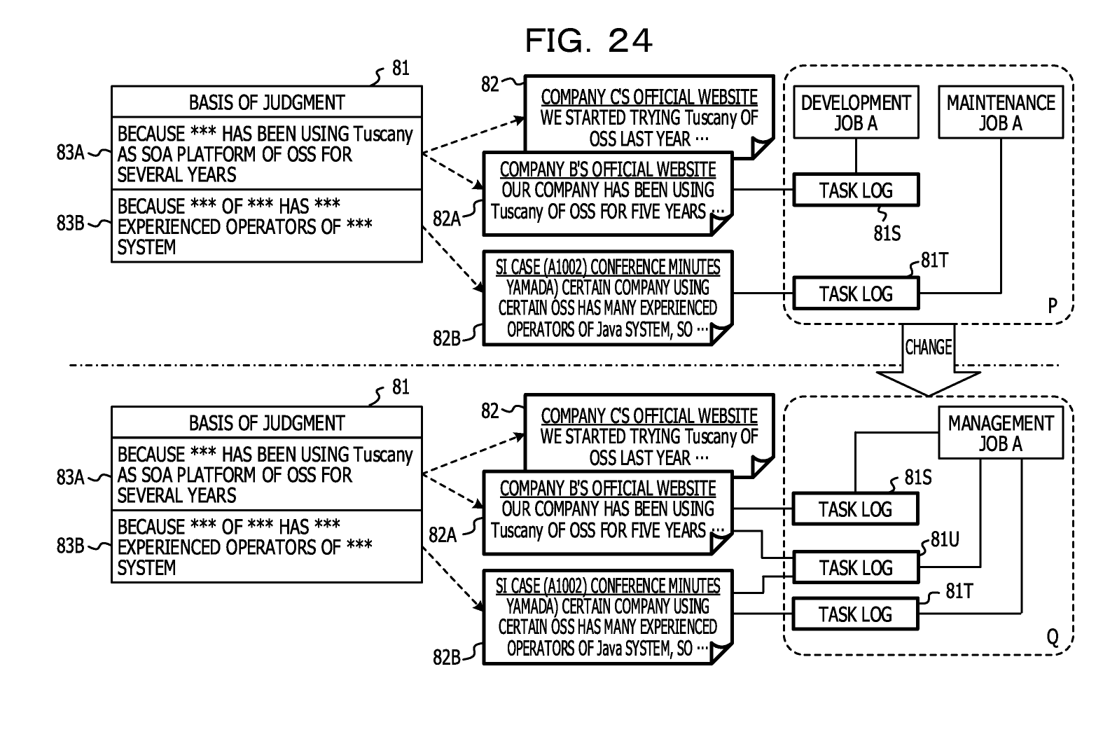

For example, it is assumed that there are a job “DEVELOPMENT JOB A” and a job “MAINTENANCE JOB A”, each of which is independent, as illustrated in P of FIG. 24. Furthermore, it is assumed that there are a document 82A that is referred to in a task log 81S corresponding to the “DEVELOPMENT JOB A” and a document 82B that is referred to in a task log 81T corresponding to the “MAINTENANCE JOB A”. Furthermore, it is assumed that the “DEVELOPMENT JOB A” and the “MAINTENANCE JOB A” are united as a “UNITED JOB A” as a result of change of the job structure and the documents 82A and 82B are referred to in a task log 81U corresponding to the “UNITED JOB A” as illustrated in Q of FIG. 24. In this case, it is easier in a case where the job structure is Q to narrow down to the combination of the document 82A and the document 82B when determining non-disclosed expressions than in a case where the job structure is P. That is, it is easier in the case where the job structure is Q to determine the non-disclosed expressions than in the case where the job structure is P, even if the same parts in the task log 81 are masked.

According to a conventional method such as k-anonymity, even in a case where there is a difference in a job structure as described above, the value of determining ease does not vary as long as the same documents 82 are retrieved based on disclosed expressions. However, according to the present embodiment, it is possible to calculate an index depending on the job structure.

Furthermore, according to the determining ease calculating device 10 according to the present embodiment, determining ease obtained in a case where a white list is changed and a task log after masking to which the changed white list has been applied are presented. This makes it possible for an administrator to intuitively grasp what degree of masking leads to what degree of risk of information being determined when determining whether to disclose a task log. It is thus possible to support determination by the administrator.

Note that although a case where determining ease is calculated by using all of the transition possibility, the identification possibility, and the relevance has been described in the above embodiment, only the relevance may be calculated as the determining ease. Alternatively, the determining ease may be calculated by using a combination of the relevance and the transition possibility or a combination of the relevance and the identification possibility.

Although a case where task logs that have been masked based on white list replacement candidates are stored not in the task log DB 21 but in the predetermined storage region has been described, the above embodiment is not limited to this. The task logs that have been masked based on white list replacement candidates may be given new task IDs and operation judgment IDs and added to the task log DB 21 as well as the task log that has been masked based on the initial white list. In this case, when a task log to be disclosed is adopted, task logs that have not adopted just have to be deleted from the task log DB.

Although an arrangement in which the determining ease calculation program 50, which is an example of the determining ease calculation program according to the disclosed technique, is stored (installed) in advance in the storage section 46 has been described above, the above embodiment is not limited to this. An image processing program according to the disclosed technique can also be provided in the form recorded in a storage medium such as a CD-ROM, a DVD-ROM, or a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of analyzing a masked task log obtained by masking part of a task log, which is a record of a task performed in a workflow system, the method comprising:
acquiring a plurality of pieces of disclosed information that are viewable to a plurality of users based on unmasked information in the masked task log;
specifying relevance between the plurality of pieces of disclosed information and a plurality of tasks performed in the workflow system, the plurality of tasks including the task; and
calculating an index based on the relevance by a processor, the index indicating a possibility that content of the masked task log is determined by using the plurality of pieces of disclosed information.

2. The method according to claim 1, wherein
the plurality of tasks are positioned so as to be associated with nodes of a tree structure indicative of a job structure in the workflow system, and
the relevance is specified in accordance with a distance between a node of the task with which the masked task log is associated and each other nodes of other tasks with which the plurality of pieces of disclosed information are associated.

3. The method according to claim 1, wherein
the task log includes a plurality of pieces of reference information that are referred, and
the plurality of pieces of reference information include the disclosed information that is viewable to the plurality of users or non-disclosed information that is viewable only to a specific user.

4. The method according to claim 3, wherein
the index is calculated by using a ratio of the number of pieces of reference information including the non-disclosed information to the total number of pieces of reference information.

5. The method according to claim 1, further comprising:
generating a plurality of other masked task logs that are associated with the task log by changing masked parts in the masked task log;
acquiring, for each of the plurality of other masked task logs, a plurality of other pieces of disclosed information that are viewable to the plurality of users based on the unmasked information;
specifying, for each of the plurality of other masked task logs, other relevance between the plurality of other pieces of disclosed information and the plurality of tasks;
calculating, for each of the plurality of other masked task logs, another index based on the other relevance, the another index indicating a possibility that content of the plurality of other masked task logs is determined by using the plurality of other pieces of disclosed information; and
displaying the index and the other index in such a manner that any one of the plurality of other masked task logs is selectable.

6. A device of analyzing a masked task log obtained by masking part of a task log, which is a record of a task performed in a workflow system, the device comprising:
a memory; and
a processor coupled to the memory and configured to:
acquire a plurality of pieces of disclosed information that are viewable to a plurality of users based on unmasked information in the masked task log,
specify relevance between the plurality of pieces of disclosed information and a plurality of tasks performed in the workflow system, the plurality of tasks including the task, and
calculate an index based on the relevance, the index indicating a possibility that content of the masked task log is determined by using the plurality of pieces of disclosed information.

7. The device according to claim 6, wherein
the plurality of tasks are positioned so as to be associated with nodes of a tree structure indicative of a job structure in the workflow system, and
the relevance is specified in accordance with a distance between a node of the task with which the masked task log is associated and each other nodes of other tasks with which the plurality of pieces of disclosed information are associated.

8. The device according to claim 6, wherein
the task log includes a plurality of pieces of reference information that are referred, and
the plurality of pieces of reference information include the disclosed information that is viewable to the plurality of users or non-disclosed information that is viewable only to a specific user.

9. The device according to claim 8, wherein
the index is calculated by using a ratio of the number of pieces of reference information including the non-disclosed information to the total number of pieces of reference information.

10. The device according to claim 6, wherein the processor is configured to:
generate a plurality of other masked task logs that are associated with the task log by changing masked parts in the masked task log,
acquire, for each of the plurality of other masked task logs, a plurality of other pieces of disclosed information that are viewable to the plurality of users based on the unmasked information,
specify, for each of the plurality of other masked task logs, other relevance between the plurality of other pieces of disclosed information and the plurality of tasks,
calculate, for each of the plurality of other masked task logs, another index based on the other relevance, the another index indicating a possibility that content of the plurality of other masked task logs is determined by using the plurality of other pieces of disclosed information, and
display the index and the other index in such a manner that any one of the plurality of other masked task logs is selectable.

11. A non-transitory storage medium storing a program for analyzing a masked task log obtained by masking part of a task log, which is a record of a task performed in a workflow system, and for causing a computer to execute a process, the process comprising:
acquiring a plurality of pieces of disclosed information that are viewable to a plurality of users based on unmasked information in the masked task log;
specifying relevance between the plurality of pieces of disclosed information and a plurality of tasks performed in the workflow system, the plurality of tasks including the task; and
calculating an index based on the relevance, the index indicating a possibility that content of the masked task log is determined by using the plurality of pieces of disclosed information.

12. The non-transitory storage medium according to claim 11, wherein
the plurality of tasks are positioned so as to be associated with nodes of a tree structure indicative of a job structure in the workflow system, and
the relevance is specified in accordance with a distance between a node of the task with which the masked task log is associated and each other nodes of other tasks with which the plurality of pieces of disclosed information are associated.

13. The non-transitory storage medium according to claim 11, wherein
the task log includes a plurality of pieces of reference information that are referred, and
the plurality of pieces of reference information include the disclosed information that is viewable to the plurality of users or non-disclosed information that is viewable only to a specific user.

14. The non-transitory storage medium according to claim 13, wherein
the index is calculated by using a ratio of the number of pieces of reference information including the non-disclosed information to the total number of pieces of reference information.

15. The non-transitory storage medium according to claim 11, wherein the process further comprising:
generating a plurality of other masked task logs that are associated with the task log by changing masked parts in the masked task log;
acquiring, for each of the plurality of other masked task logs, a plurality of other pieces of disclosed information that are viewable to the plurality of users based on the unmasked information;
specifying, for each of the plurality of other masked task logs, other relevance between the plurality of other pieces of disclosed information and the plurality of tasks;
calculating, for each of the plurality of other masked task logs, another index based on the other relevance, the another index indicating a possibility that content of the plurality of other masked task logs is determined by using the plurality of other pieces of disclosed information; and
displaying the index and the other index in such a manner that any one of the plurality of other masked task logs is selectable.
